(19) United States
(12) Patent Application Publication
(10) Pub. No.: US 2013/0206933 A1
(43) Pub. Date: Aug. 15, 2013

(54) Adjustable Stand

(71) Applicant: Leica Microsystems (Schweiz) AG, (US)

(72) Inventors: Marco Schutz, Rorschach (CH); Roman Frick, Speicher (CH)

(73) Assignee: LEICA MICROSYSTEMS (SCHWEIZ) AG, HEERBRUGG (CH)

(21) Appl. No.: 13/765,023

(22) Filed: Feb. 12, 2013

(30) Foreign Application Priority Data
Feb. 15, 2012 (DE) 10 2012 202 303.8

(51) Int. Cl. F16M 11/18

(52) U.S. Cl. CPC F16M 11/18
USPC 248/123.2

(57) ABSTRACT

The present invention relates to an adjustable stand having a first arm (104) that is rotatable about a first rotation axis (102a), and a second arm (106) that is attached articulatedly at one end of the first arm (104), a mounting apparatus (110) being provided at the distal end of the second arm (106), further having a compensation mass (120, 130) operatively connected to the first arm (104), the compensation mass (120, 130) being provided at least partly displaceably back and forth along an axis (200) that is directed toward the first rotation axis (102a).

### CROSS REFERENCE TO RELATED APPLICATIONS

This application claims priority of German patent application number 10 2012 202 303.8 filed Feb. 15, 2012, the entire disclosure of which is incorporated by reference herein.

### FIELD OF THE INVENTION

The present invention relates to an adjustable stand.

### BACKGROUND OF THE INVENTION

For easy handling of heavy medical observation devices such as, for example, surgical microscopes, it is usual to provide adjustable stands on which the observation devices can be secured or mounted. It is usual in this context, in order to ensure sensitive and simple horizontal and vertical movability requiring little effort, to embody compensation weights on the stand that serve to counterbalance the weight of the optical observation device attached to the stand. Because it is moreover typical for different optical observation devices that correspondingly have different weights to be used together with a stand, it must also be possible to adapt the compensation weights to different medical observation devices.

U.S. Pat. No. 6,050,530 A proposes for these purposes a displaceability of counterweights on the stand by means of corresponding horizontal and vertical slide mechanisms. These slide mechanisms are perceived as relatively complex; the need to position compensation weights at different positions on the stand and to immobilize (secure) them at those positions is also associated with a relatively high level of complexity.

### SUMMARY OF THE INVENTION

The object of the present invention is to provide an adjustable stand that is adaptable in a simple and reliable way to a plurality of medical observation devices of differing weights.

This object is achieved by an adjustable stand described herein.

The stand according to the present invention makes available a system which can be counterbalanced in simple fashion, and with which optical observation devices, for example surgical microscopes, can be handled in a simple and reliable way. According to the present invention, a displacement of a compensation mass in only a single direction is necessary. As a result, a very simple adjustment mechanism can be implemented.

The at least partial displaceability of the compensation mass along an axis that is directed toward the first rotation axis of the stand proves to be particularly advantageous, this first rotation axis being the rotation axis about which the stand as a whole is rotatable or pivotable. Particularly effective compensation mass displacement is thereby provided. Be it noted that this axis can be a real or a virtual axis.

Advantageous embodiments of the invention are described throughout the specification.

Preferably, the compensation mass comprises a first mass that is not displaceable, and a second compensation mass that is displaceable back and forth in the direction toward the first rotation axis. This feature ensures that only a portion of the (total) compensation mass needs to be provided displaceably. The result is that corresponding drive systems for displacement of the compensation mass can be of smaller dimensions as compared with conventional approaches, so that the stand as a whole can be physically smaller and costs can be reduced.

It proves to be particularly useful that the mounting apparatus provided on the second arm of the stand is rotatable about a second rotation axis that is provided on the second arm, this second rotation axis being oriented parallel to the first rotation axis, the second rotation axis extending through an (imaginary) prolongation of the axis on which the compensation mass is at least partly displaceable back and forth.

In this context, the axis along which the compensation mass is at least partly displaceable back and forth usefully extends perpendicularly to the extension direction of the first rotation axis, and thus also perpendicularly to the second rotation axis.

All in all, the so-called neutral axis of the stand extends along the axis on which the compensation mass is at least partly displaceable back and forth, and along its (imaginary) prolongation. Adjustments of the compensation mass along this neutral axis prove to be very effective, i.e. a relatively large torque can be compensated for with a relative short displacement.

It proves to be particularly advantageous to provide the first arm as a parallel-member link or articulated parallelogram having an inner rod and an outer rod, the first rotation axis being implemented on the inner rod, the at least partly displaceable compensation mass being attached to a holder that is supported pivotably about a further rotation axis on a prolongation of a connecting rod of the first parallel-member link, the holder being provided with a guide into which a guide element, provided on the outer rod of the first parallel-member link, engages. This feature provides a design that is particularly simple mechanically, with which it is possible to ensure that the axis along which the compensation mass is at least partly displaceable back and forth, the first rotation axis, and the second rotation axis lie on the neutral axis of the stand. All that is necessary for this is to ensure that the guide element between the at least partly displaceable compensation mass and the first rotation axis likewise lies on this neutral axis.

Expediently, the second arm is also embodied as a parallel-member link having a first and a second rod.

Expediently, the stand according to the present invention comprises at least one sensor element by means of which moments (torques) acting on the stand can be sensed, as well as a control system, interacting with the at least one sensor element, that controls to a drive system in such a way that the compensation mass is displaceable. Components of this kind make possible in simple fashion an adjustment of the stand as a function of an optical apparatus, in particular a surgical microscope, attached to the mounting apparatus.

The stand expediently comprises a braking device by means of which the positions of the stand can be immobilized once established.

Further advantages and embodiments of the invention are evident from the description and the appended drawings.

It is understood that the features recited above and those yet to be explained below are usable not only in the respective combination indicated, but also in other combinations or in isolation, without departing from the scope of the present invention.

The invention is schematically depicted in the drawings on the basis of an exemplifying embodiment, and will be described below in detail with reference to the drawings.

### BRIEF DESCRIPTION OF THE DRAWINGS

In the drawings:

FIG. 1 is a schematic side view of a preferred embodiment of an adjustable stand according to the present invention.

### DETAILED DESCRIPTION OF THE INVENTION

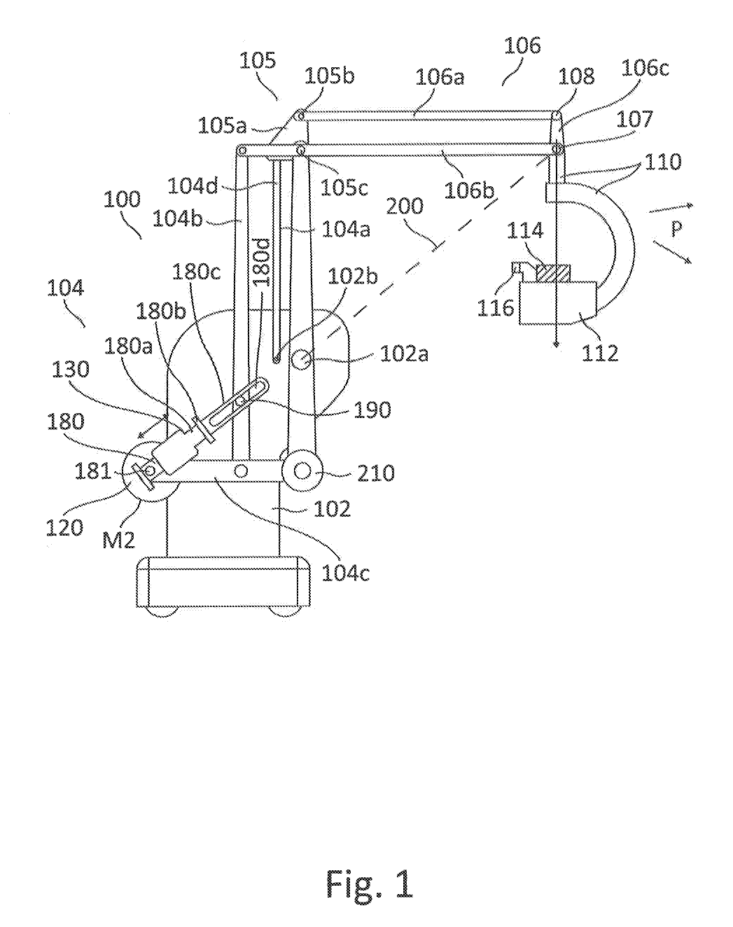

A preferred embodiment of an adjustable stand according to the present invention is designated 100 in its entirety in FIG. 1. The stand has as a carrier element a carrier column 102 on which a parallel-member linkage is pivotably supported.

The parallel-member linkage comprises, as a first arm, a first parallel-member link 104 having rods 104a, 104b, and as a second arm a second parallel-member link 106 having rods 106a, 106b. Parallel-member linkage 104, 106 is pivotable as a whole about a rotation axis 102a that is provided on carrier column 102. Parallel-member link 106 is furthermore pivotable with respect to parallel-member link 104 by means of a mechanism 105 that comprises an angle element 105a and rotation axes 105b, 105c. Parallel-member link 106 thus serves as an extension arm for parallel-member link 104. Further rotation axes of the parallel-member linkage are depicted in the drawing by means of small circles, but for the sake of clarity not all are labeled with reference numerals. A braking or locking device 210, with which the positions of the stand can be defined once established, is expediently provided. This device can be provided, for example, in the vicinity of rotation axis 102a or of a rotation axis at one end of one of rods 104a. In FIG. 1 this device 210 is provided, for example, at the lower end of rod 104a.

A medical optical apparatus, in particular a surgical microscope 112, optionally comprising auxiliary apparatuses 114, 116, is mounted at the free or distal end 106c of parallel-member link 106 by means of a mounting apparatus 110.

In order to counterbalance the moments (torques) generated by the weight of medical optical apparatus 112 (and optionally of auxiliary apparatuses 114, 116), a first compensation weight 120 is embodied on a prolongation of a horizontal connecting rod 104c of first parallel-member link 104, which connects first or inner rod 104a and second or outer rod 104b. A holder 180 for a second compensation mass 130 is furthermore provided at that end of the prolongation of connecting rod 104c at which first compensation mass 120 is also provided. This holder 180 is pivotable about a rotation axis 181 relative to the prolongation of connecting rod 104c. Holder 180 comprises a first region 180a that is embodied as a linear guide on which second compensation mass 130 (constituting a linear carriage) is displaceable back and forth and can be immobilized at a desired position. The displaceability of second compensation mass 130 is limited by stops or other suitable means. For clarity, only one stop 180b is depicted in FIG. 1.

Adjacent to this stop 180b is a second region 180c of holder 180. This second region 180c comprises an elongated hole 180d the principal extension direction of which corresponds to the displaceability direction of second compensation mass 130. First region 180a and second region 180c of holder 180 can expediently be provided in one piece, stop 180b being positionable and immobilizable at a desired location.

Elongated hole 180d serves as a guide for a guide element 190 provided on outer rod 104b of first parallel-member link 104. Guide element 190 can be provided, for example, as a guide pin.

The position of guide element 190 on rod 104b is selected so that the guide element lies on an (imaginary) connecting line between rotation axis 181 and rotation axis 102a of first parallel-member link 104 on second rod 104a. This line or axis is depicted in FIG. 1 and labeled 200. The consequence of this is that a displacement of second compensating mass 130 along first region 180a, serving as a linear guide, of holder 180 always occurs along said line 200, i.e. along an axis in the direction toward or away from rotation axis 102a. At the same time, this displacement occurs perpendicular to rotation axes 181 and 102a.

It is evident that a further rotation axis, namely rotation axis 107 of mount 110 on the second or inner rod 106b of second parallel-member link 106, lies on a (once again imaginary) prolongation of line 200. Line 200 thus represents the neutral axis of the stand.

A further rod 104d is provided between rods 104a, 104b of first parallel-member link 104. This rod is pivotable at its first end about a pivot point 102b on carrier element 102, and at its second end is connected to angle element 105a of mechanism 105.

It is further evident that mounting apparatus 110 is attached on a prolongation of a connecting rod 106c that connects to one another the two rods 106a and 106b of second parallel-member link 106.

Connecting rod 106c is pivotable on rotation axis 107 with respect to rod 106b, and on a rotation axis 108 with respect to rod 106a. This pivotability ensures a perpendicular orientation of connecting rod 106c in any position of stand 100 that can be established, as will be further explained below.

Let it be assumed firstly that stand 100 is in equilibrium in the position depicted in FIG. 1. This means that the moments acting on connecting rod 106c, which are caused substantially by surgical microscope 112 and optionally by further components 114, 116 (and optionally by the weight of mounting apparatus 110), correspond to the moments caused by compensation masses 120, 130. In order to establish this equilibrium, displaceable weight 130 is positioned and immobilized at a suitable position along first region 181 of holder 180.

If the mass attached to mounting apparatus 110 is modified, for example by installing a heavier surgical microscope 112 and/or attaching a further or heavier auxiliary apparatus 112, 114, a torque sensor positioned at a suitable location detects a static imbalance resulting therefrom. The values acquired by a sensor of this kind are usefully forwarded to a control device (not depicted) that, by applying control to a drive system (not depicted), brings about a corresponding displacement outward, i.e. in the direction of pivot point 181, of second compensation mass 130 along first region 180a of holder 180. The additional moment acting on connecting rod 160c can thereby be effectively compensated for.

The above-described equilibration of stand 100 makes possible a very rapid adjustment of the stand requiring very little energy, for example in the case of a displacement in the direction of one of arrows P. The mechanism depicted ensures that in all positions of pivot point 181 that can be established, guide element 190, rotation axis 102a, and rotation axis 107 lie on one line (neutral axis 200).

The impingement of third rod 104d of first parallel-member link 104 on pivot mechanism 105 further causes transverse rod 106c, and thus a surgical microscope attached thereto, always to be mounted or orientated perpendicularly.

As depicted, with stand 100 in any position that can be established, it is possible in simple fashion to counterbalance the stand for surgical microscopes or auxiliary devices of different masses by displacing second compensation mass 130. It proves to be particularly advantageous that in accordance with the approach depicted, only second compensation mass 130 needs to be displaced. First compensation mass 120 can be provided in stationary fashion with respect to the prolongation of connecting rod 104c. In particular, second compensation mass 130 can be substantially smaller than first compensation mass 120. A drive system of very small dimensions can therefore be used for the displacement of second compensation mass 130.

The invention is not to be limited to the specific embodiments disclosed, and modifications and other embodiments are intended to be included within the scope of the invention.

### PARTS LIST

100 Adjustable stand

102 Carrier column or carrier element

102a Rotation axis

104 Parallel-member link

104a, 104b Rods

104c Connecting rod

105 Pivot mechanism

105a Angle element

105b, 105c Rotation axes

106 Parallel-member link

106a, 106b Rods

106c Free or distal end

107, 108 Rotation axes

110 Mounting apparatus

112 Medical optical apparatus, in particular surgical microscope

114, 116 Auxiliary apparatuses

120 First compensation mass

130 Second compensation mass

160 Braking or locking device

180 Holder

180a First region of holder (linear guide)

180b Stop

180c Second region of holder

180d Elongated hole

181 Rotation axis

190 Guide element

200 Neutral axis (line)

210 Braking or locking device

What is claimed is:

1. An adjustable stand, comprising:
a first arm (104) that is rotatable about a first rotation axis (102a);
a second arm (106) that is attached articulatedly at one end of the first arm (104);
a mounting apparatus (110) at the distal end of the second arm (106);
a compensation mass (120, 130) operatively connected to the first arm (104);
wherein the compensation mass (120, 130) is at least partly displaceable along an axis (200) that is directed toward the first rotation axis (102a).

2. The stand according to claim 1, wherein the compensation mass includes a non-displaceable first mass (120), and a second compensation mass (130) that is displaceable along the axis (200) that is directed toward the first rotation axis (102a).

3. The stand according to claim 1, wherein the mounting apparatus is rotatable about a second rotation axis (107) on the second arm (106), the second rotation axis (107) being parallel to the first rotation axis (102a), and the second rotation axis (107) extending through an imaginary prolongation of the axis (200) along which the compensation mass is at least partly displaceable along.

4. The stand according to claim 1, wherein the first arm (104) is a parallel-member link or articulated parallelogram including an inner rod (104a) and an outer rod (104b), the first rotation axis (102a) being on the inner rod (104a), the compensation mass being attached to a holder (180) that is pivotably supported about a rotation point (181) on a prolongation of a connecting rod (104c) that connects the inner rod (104a) and the outer rod (104b) to one another, the holder (180) having a guide (180c) into which a guide element (190) on the outer rod (104b) of the first parallel-member link engages.

5. The stand according to claim 4, wherein the second arm (106) is a parallel-member link having a first rod (106a) and a second rod (106b).

6. The stand according to claim 1, further comprising at least one sensor element configured to sense torques or moments acting on the stand; and
a control system, in communication with the at least one sensor element, configured to control a drive device, the drive device configured to displace the compensation mass.

7. The stand according to claim 1, further comprising a braking device (210) configured to immobilize the stand in a plurality of positions.
